(19) United States
(12) Patent Application Publication
(10) Pub. No.: US 2012/0255234 A1
(43) Pub. Date: Oct. 11, 2012

(54) SAFETY GATE

(76) Inventor: TSUNG-HSIANG WANG, NEW TAIPEI CITY (TW)

(21) Appl. No.: 13/166,642

(22) Filed: Jun. 22, 2011

(30) Foreign Application Priority Data
Apr. 8, 2011 (CN) 201120100455.2

(51) Int. Cl. E06B 9/02; E05B 65/06

(52) U.S. Cl. 49/395; 49/394

(57) ABSTRACT

A safety gate has a gate frame, a pivotable fence, a latch device and a fence stopper. The gate frame has a base, two side frames and a block formed on the base. The pivotable fence is mounted within the gate frame. One side of the pivotable fence is pivotally mounted within the gate frame by a pivoting element. The latch device has a first pin member and a first latch member respectively having two magnets corresponding to each other. The fence stopper abuts against the block to limit the pivotable fence to be unidirectionally pivotable. The attraction force between the magnets and a restoring force of the pivoting element return the pivotable fence back within the gate frame. The fence stopper and the block abut against each other to avoid the circumstance when the pivotable fence is slammed too hard and the latch device is not securely locked.

### BACKGROUND OF THE INVENTION

1. Field of the Invention

The present invention relates to a safety gate, and more particularly to a safety gate having magnets for facilitating the positioning of the safety gate.

2. Description of the Related Art

Safety gates serve to block young children or pets at the top of stairs for a fall protection or at the entrance to a room or an area, such as kitchen, living room or balcony, to limit the young children or pets to stay in the room or from accessing the room. However, sometime when parents do not lock the safety gate firmly due to carelessness, young children may still be able to pass through an open gap of the unlocked safety gate to enter a dangerous zone. A Chinese Utility Model Application Number 201020139726 entitled “Fence gate having alarm capability” is disclosed to present a color board mounted for alerting purpose on the locking device for the safety gate. The color board displays one color when the safety gate is securely locked, and displays the other color when the safety gate is insecurely locked.

However, if the foregoing safety gate is pushed or pulled too hard, the color board may signal a color indicating a securely locked state of the safety gate while the safety gate is in fact unlocked by the excessively applied force. Such a circumstance could be dangerous or life-threatening to young children.

### SUMMARY OF THE INVENTION

An objective of the present invention is to provide a safety gate capable of enhancing the positioning capability of the safety gate.

To achieve the foregoing objective, the safety gate has a gate frame, a pivotable fence and a latch device.

The gate frame has a base and a first side frame and a second side frame. The base has a top, two ends and a block. The block is mounted on the top of the base. The first side frame and the second side frame are respectively and vertically mounted on two locations of the top of the base adjacent to the two ends of the base.

The pivotable fence is pivotally mounted within the first side frame, the second side frame and the base, and has a first side bar, a second side bar, multiple intermediate bars and a pivoting element. The first side bar is adjacent to the first side frame. The second side bar is adjacent to the second side frame and has a top. The intermediate bars are mounted between the first side bar and the second side bar. The pivoting element is mounted on the top of the second side bar, and is pivotally mounted on the top of the second side frame.

The latch device has at least one pin and latch assembly. One of the at least one pin and latch assembly is mounted between the first side frame and the first side bar of the pivotable fence and has a first pin member and a first latch member. The first pin member and the first latch member engage each other and respectively have two magnets, the magnet of the first pin member is adjacent to the magnet of the first latch member, and the magnets of the first pin member and the first latch member attract each other.

Preferably, the first pin member has a first rod mounted in the first pin member and being extendable beyond one end of the first pin member facing the first side bar and is restorable to the inside of the first pin member, and the first latch member has a first slot formed in the first latch member, facing the first rod for the first rod to engage the first slot, and having a first bevel surface formed on a bottom wall of the first slot in a vertical direction.

Preferably, the pivoting element has a restoring force pivoting the pivotable fence back within the first side frame and the second side frame, and enables the pivotable fence to be moved up and down within a preset range.

Preferably, the latch device has two pin and latch assemblies, the other pin and latch assembly has a second pin member and a second latch member. The second pin member is mounted in the bottom of the pivotable fence, faces the first side frame and has a second rod mounted on and resiliently extendable beyond a side of the second pin member. The second latch member is mounted on a bottom of the first side frame to align with the second pin member for the second pin member to engage the second latch member.

Preferably, the power socket further has a fence stopper. The fence stopper is mounted on a location of the bottom of the pivotable fence corresponding to the block of the gate frame and has two stops respectively mounted on two sides of the pivotable fence, and each stop is pivotable toward the base to abut against the base and the block so as to block the pivotable fence to be unidirectionally pivotable.

The safety gate of the present invention has the following advantages and effects.

1. The two magnets respectively mounted on the first pin member and the first latch member attract each other to facilitate the engagement between the first pin member and the first latch member, thereby preventing the latch device from being insecurely locked when the pivotable fence is slammed too hard.

2. The pivoting element provides a restoring force to return the pivotable fence back within the gate frame and facilitate locking the latch device.

3. The block enhances the stops of the fence stopper in limiting the pivotable fence to be unidirectionally pivotable, thereby preventing the latch device from being insecurely locked when the pivotable fence is slammed too hard.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a safety gate in accordance with the present invention;

FIG. 2 is an operational perspective view of the safety gate in FIG. 1;

FIG. 3 is an enlarged exploded perspective view in partial section of the safety gate in FIG. 1;

FIG. 4 is an enlarged front view in partial section of the safety gate in FIG. 1;

FIG. 5 is another enlarged front view in partial section of the safety gate in FIG. 1; and

FIG. 6 is an enlarged operational perspective view of the safety gate in FIG. 1.

### DETAILED DESCRIPTION OF THE INVENTION

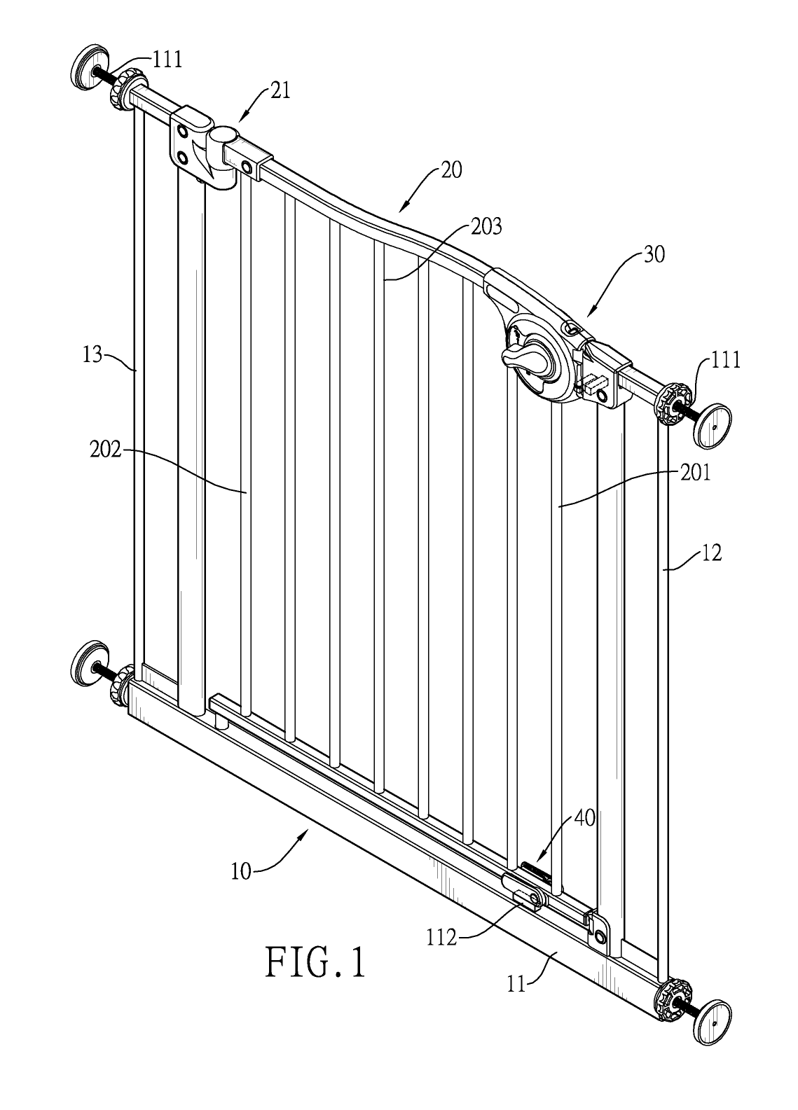

With reference to FIG. 1, a safety gate in accordance with the present invention has a gate frame 10, a pivotable fence 20, a latch device 30 and a fence stopper 40.

The gate frame 10 has a base 11, a first side frame 12 and a second side frame 13. The base 11 is elongated and has a block 112. The block 112 is mounted on a top of the base 11. The first side frame 12 and the second side frame 13 are respectively and vertically mounted on two locations of the top of the base 11 adjacent to two ends of the base 11 of the gate frame 10. Each of the first side frame 12 and the second side frame 13 has two contact pads 111. The contact pads 111 are respectively mounted on a top and a bottom of each of the first side frame 12 and the second side frame 13 for the gate frame 10 to be securely mounted on a place, such as an entrance to a kitchen.

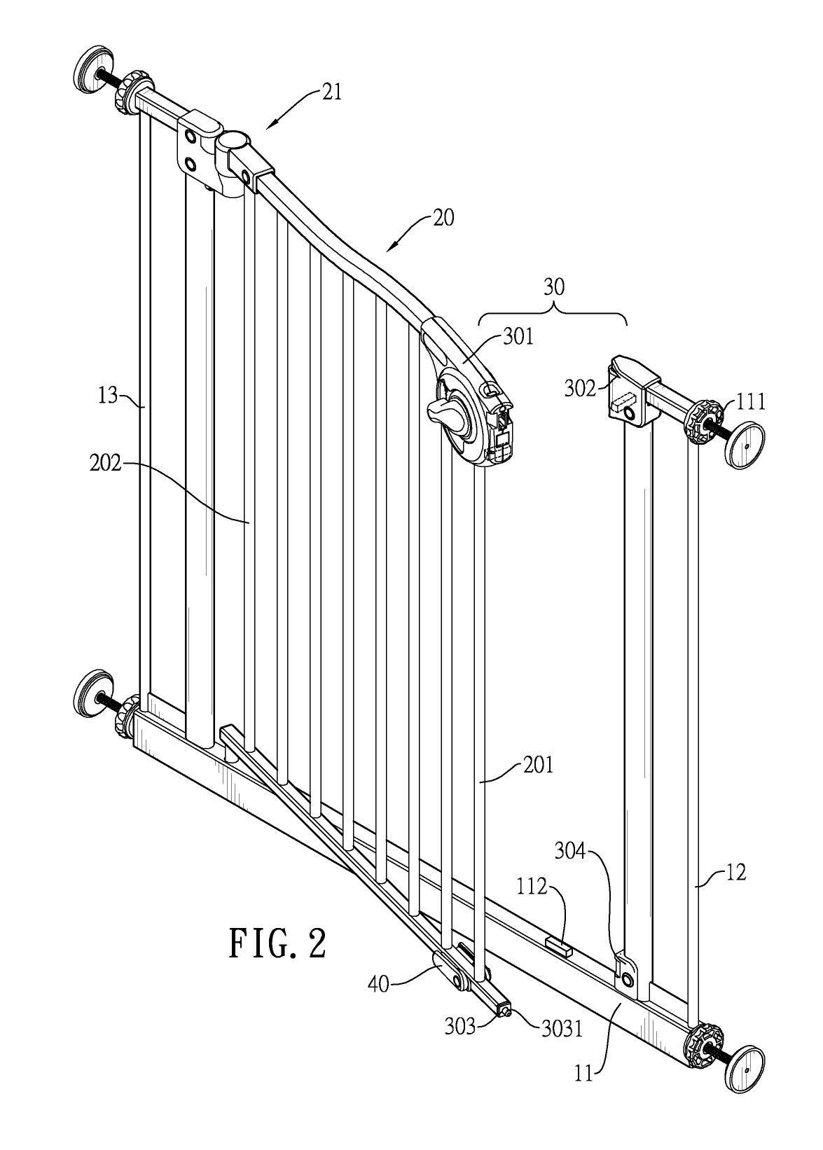

With reference to FIG. 2, the pivotable fence 20 is pivotally mounted within the first side frame 12, the second side frame 13 and the base 11. A bottom of the pivotable fence 20 corresponds to the base 11. The pivotable fence 20 has a first side bar 201, a second side bar 202, multiple intermediate bars 203 and a pivoting element 21. The first side bar 201, the second side bar 202 and the intermediate bars 203 are vertically mounted on the bottom of the pivotable fence 20. The first side bar 201 is adjacent to the first side frame 12. The second side bar 202 is adjacent to the second side frame 13. The intermediate bars 203 are mounted between the first side bar 201 and the second side bar 202. The pivoting element 21 is mounted on a top of the second side bar 201, is pivotally mounted on the top of the second side frame 13, has a restoring force pivoting the pivotable fence 20 back within the first side frame 12 and the second side frame 13, and enables the pivotable fence 20 to be moved up and down within a preset range.

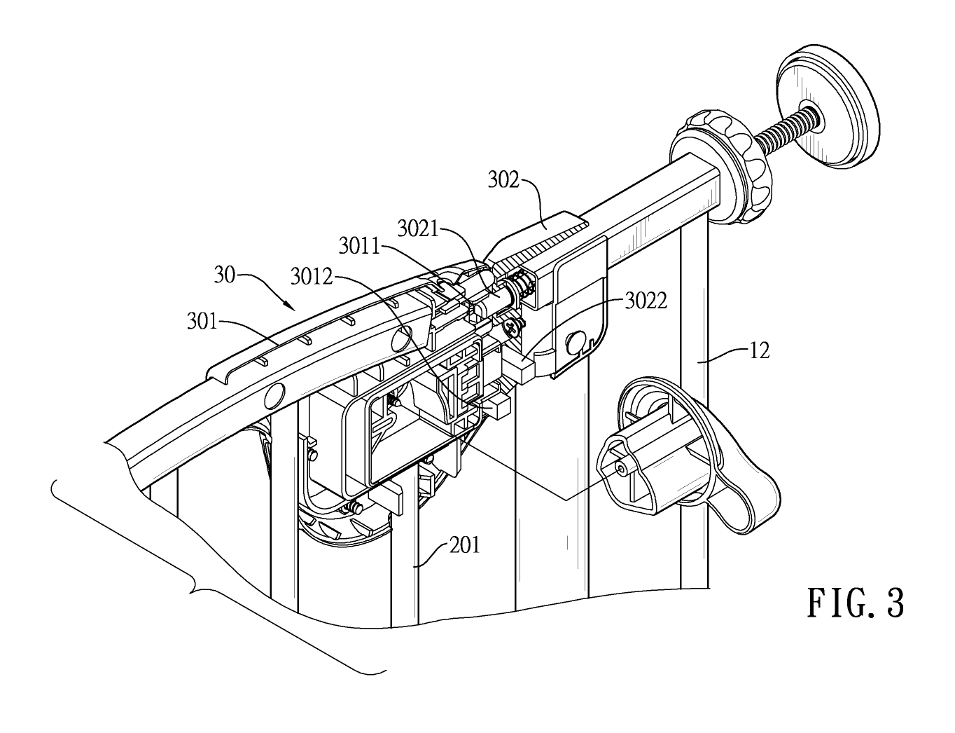

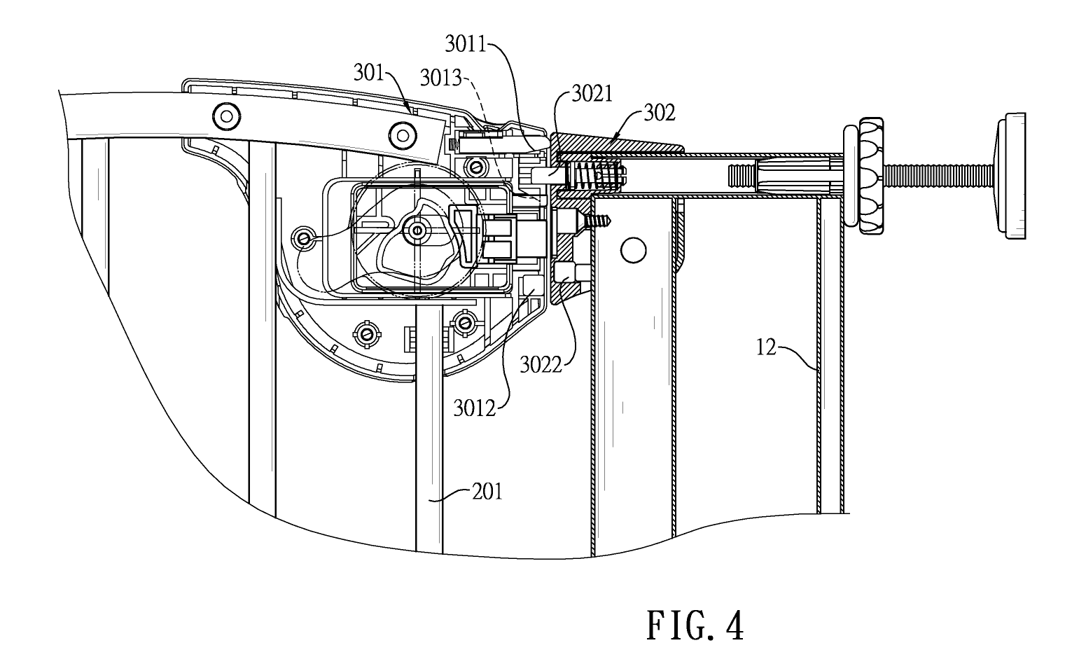

With reference to FIGS. 3 to 5, the latch device 30 has at least one pin and latch assembly. In the present embodiment, the latch device 30 has two pin and latch assemblies. The two pin and latch assemblies are mounted between the first side frame 12 and the first side bar 201 of the pivotable fence 20. One pin and latch assembly has a first pin member 302 and a first latch member 301. The other pin and latch assembly has a second pin member 303 and a second latch member 304. The first latch member 301 and the first pin member 302 engage each other. The first pin member 302 is mounted on a top of the first side frame 12 and is adjacent to the first side bar 201 of the pivotable fence 20, and has a first rod 3021 and a pin magnet 3022. The first rod 3021 is mounted in the first pin member 302 and is extendable beyond one end of the first pin member 302 facing the first side bar 201 and is restorable to the inside of the first pin member 302. The first latch member 301 is mounted on a top of the pivotable fence 20, faces the first pin member 302, and has a first slot 3011 and a latch magnet 3012. The first slot 3011 is formed in the first latch member 301, faces the first rod 3021 for the first rod 3021 to engage the first slot 3011, and has a first bevel surface 3013 formed on a bottom wall of the first slot 3011 in a vertical direction. When the pivotable fence 20 is moved upwardly relative to the gate frame 10, the first rod 3021 engaging the first slot 3011 is slid along the first bevel surface 3013 to disengage from the first slot 3011. The latch magnet 3012 of the first latch member 301 is adjacent to the pin magnet 3022 of the first pin member 302. The attraction force between the latch magnet 3012 and the pin magnet 3022 facilitates restoring the pivotable fence 20 back to the position within the gate frame 12.

The second pin member 303 is mounted in the bottom of the pivotable fence 20, faces the first side frame 12 and has a second rod 3031 mounted on and resiliently extendable beyond a side of the second pin member 303. The second latch member 304 is mounted on a bottom of the first side frame 12 to align with the second pin member 303, and has a second slot 3041. The second slot 3041 is formed in the second latch member 304, faces the second rod 3031 for the second rod 3031 to engage the second slot 3041, and has a second bevel surface 3042 formed on a top wall of the second slot 3041 in a vertical direction. When the pivotable fence 20 is moved upwardly relative to the gate frame 10, the second rod 3031 engaging the second slot 3041 is slid along the second bevel surface 3042 to disengage from the second slot 3041. Hence, when the pivotable fence 20 is moved upwardly relative to the gate frame 10, the first rod 3021 of the first pin member 302 disengages from the first slot 3011 of the first latch member 301 and the second rod 3031 of the second pin member 303 disengages from the second slot 3041 of the second latch member 304 to unlock the latch device 30.

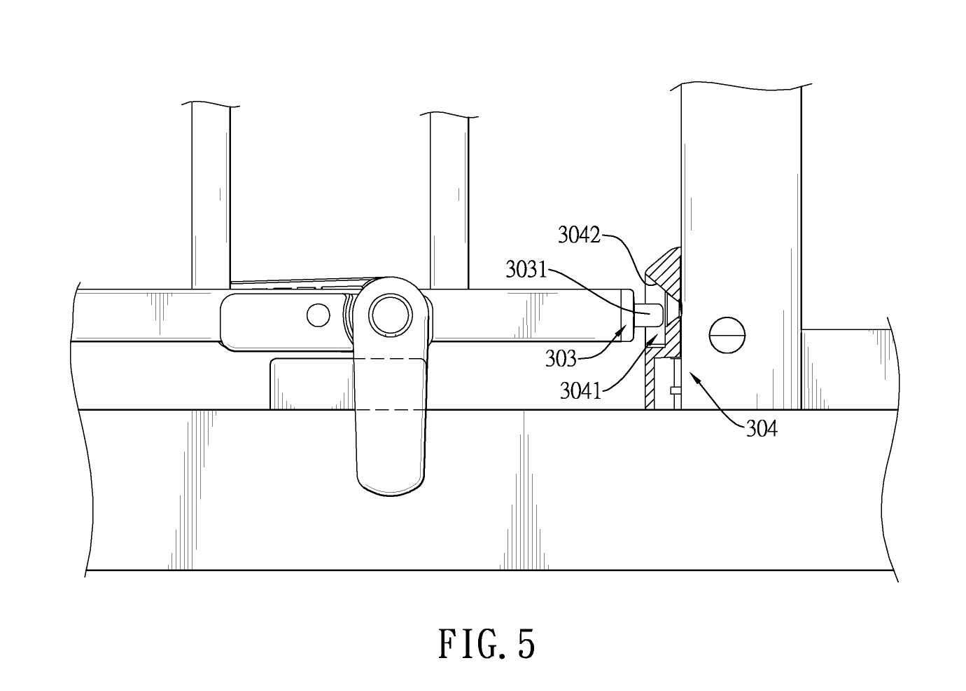

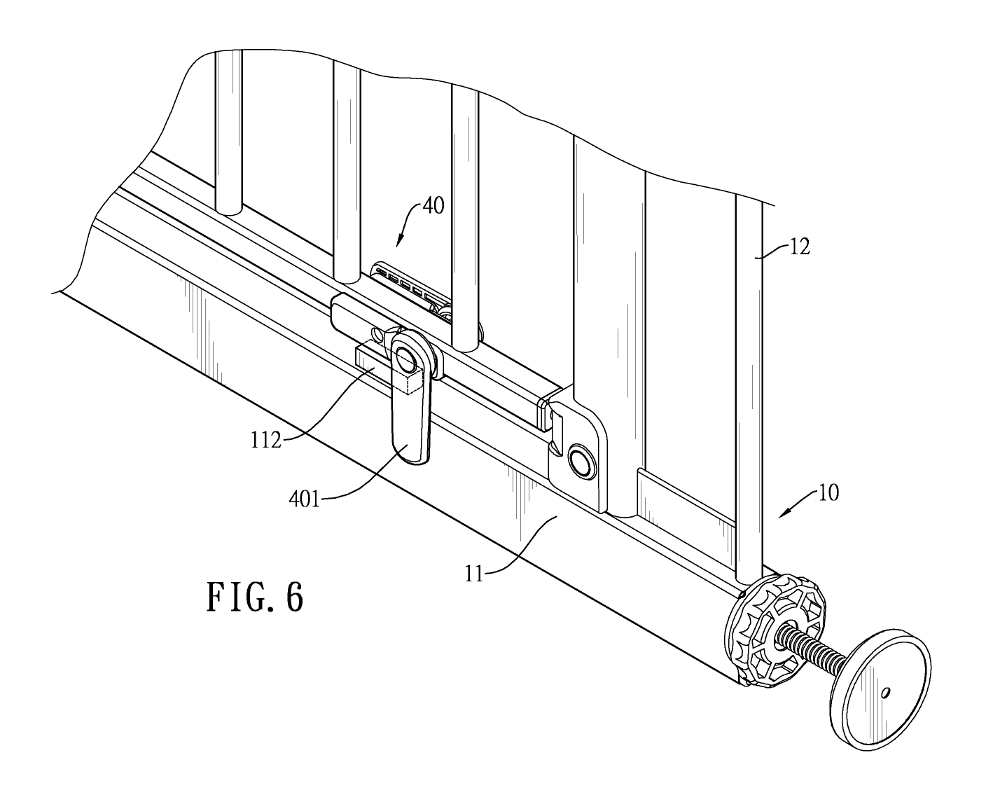

With reference to FIGS. 5 and 6, the fence stopper 40 is mounted on a location on the bottom of the pivotable fence 20 corresponding to the block 112 of the gate frame 10 so as to limit the pivotable fence 20 to open unidirectionally. The fence stopper 40 has two stops 401 respectively mounted on two sides of the pivotable fence 20. Each stop 401 is pivotable toward the base 11 to abut against the base 11 and the block 112 so as to block the pivotable fence 20 to be unidirectionally pivotable. The abrasion between the block 112 and the pivotable fence 20 facilitates the pivotable fence 20 to be positioned within the gate frame 10.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A safety gate comprising:
a gate frame having:
a base having:
a top;
two ends; and
a block mounted on the top of the base; and
a first side frame and a second side frame respectively mounted on two locations of the top of the base adjacent to the two ends of the base;
a pivotable fence pivotally mounted within the first side frame, the second side frame and the base, and having:
a first side bar being adjacent to the first side frame;
a second side bar being adjacent to the second side frame and having a top;
multiple intermediate bars mounted between the first side bar and the second side bar; and
a pivoting element mounted on the top of the second side bar, and pivotally mounted on the top of the second side frame; and
a latch device having at least one pin and latch assembly, wherein one of the at least one pin and latch assembly is mounted between the first side frame and the first side bar of the pivotable fence and has a first pin member and a first latch member, the first pin member and the first latch member engage each other and respectively have two magnets, the magnet of the first pin member is adjacent to the magnet of the first latch member, and the magnets of the first pin member and the first latch member attract each other.

2. The safety gate as claimed in claim 1, wherein
the first pin member has a first rod mounted in the first pin member and being extendable beyond one end of the first pin member facing the first side bar and is restorable to the inside of the first pin member, and
the first latch member has a first slot formed in the first latch member, facing the first rod for the first rod to engage the first slot, and having a first bevel surface formed on a bottom wall of the first slot in a vertical direction.

3. The safety gate as claimed in claim 1, wherein the pivoting element has a restoring force pivoting the pivotable fence back within the first side frame and the second side frame, and enables the pivotable fence to be moved up and down within a preset range.

4. The safety gate as claimed in claim 2, wherein the pivoting element has a restoring force pivoting the pivotable fence back within the first side frame and the second side frame, and enables the pivotable fence to be moved up and down within a preset range.

5. The safety gate as claimed in claim 3, wherein the latch device has two pin and latch assemblies, and the other pin and latch assembly has:
a second pin member mounted in the bottom of the pivotable fence, facing the first side frame and having a second rod mounted on and resiliently extendable beyond a side of the second pin member; and
a second latch member mounted on a bottom of the first side frame to align with the second pin member for the second pin member to engage the second latch member.

6. The safety gate as claimed in claim 4, wherein the latch device has two pin and latch assemblies, and the other pin and latch assembly has:
a second pin member mounted in the bottom of the pivotable fence, facing the first side frame and having a second rod mounted on and resiliently extendable beyond a side of the second pin member; and
a second latch member mounted on a bottom of the first side frame to align with the second pin member for the second pin member to engage the second latch member.

7. The safety gate as claimed in claim 5 further comprising a fence stopper, wherein the fence stopper is mounted on a location on the bottom of the pivotable fence corresponding to the block of the gate frame and has two stops respectively mounted on two sides of the pivotable fence, and each stop is pivotable toward the base to abut against the base and the block so as to block the pivotable fence to be unidirectionally pivotable.

8. The safety gate as claimed in claim 6 further comprising a fence stopper, wherein the fence stopper is mounted on a location on the bottom of the pivotable fence corresponding to the block of the gate frame and has two stops respectively mounted on two sides of the pivotable fence, and each stop is pivotable toward the base to abut against the base and the block so as to block the pivotable fence to be unidirectionally pivotable.
